(19) United States
(12) Patent Application Publication
(10) Pub. No.: US 2009/0136828 A1
(43) Pub. Date: May 28, 2009

(54) Carbon Nanotube Electrodes and Method for Fabricating Same for Use in Biofuel Cell and Fuel Cell Applications

(75) Inventors: Jae-Woo Kim, Newport News, VA (US); Peter T. Lillehei, Yorktown, VA (US); Cheol Park, Yorktown, VA (US); Sang H. Choi, Poquoson, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignees: United States of America as represented by the Administrator of the National Aeronautics and; Space Administration, Washington, DC (US)

(21) Appl. No.: 12/272,830

(22) Filed: Nov. 18, 2008

Related U.S. Application Data
(60) Provisional application No. 60/990,111, filed on Nov. 26, 2007.

(51) Int. Cl. H01M 4/02; H01M 4/88

(52) U.S. Cl. 429/44; 502/101; 977/750; 977/752

(57) ABSTRACT

Carbon nanotubes (CNTs) are mixed in an aqueous buffer solution that includes a buffer material having a molecular structure defined by a first end, a second end, and a middle disposed between the first and second ends. The first end is a cyclic ring with nitrogen and oxygen heteroatomes, the middle is a hydrophobic alkyl chain, and the second end is a charged group. The resulting solution includes the CNTs dispersed therein. Metal-core ferritins are then mixed into the resulting solution where at least a portion of the ferritins are coupled to the CNTs.

Pursuant to 35 U.S.C. §119, the benefit of priority from provisional application 60/990,111, with a filing date of Nov. 26, 2007, is claimed for this non-provisional application.

The invention was made in part by employees of the United States Government and may be manufactured and used by or for the Government of the United States of America for governmental purposes without the payment of any royalties thereon or therefor.

### BACKGROUND OF THE INVENTION

1. Field of the Invention

This invention relates to electrodes used in biofuel cells and fuel cells. More specifically, the invention is carbon nanotube-based electrodes and method for fabricating same where the electrodes are suitable for use in biofuel cell and fuel cell applications.

2. Description of the Related Art

Fuel cells represent a potential solution to the many problems presented by crude oil-based fuel for vehicles. The basic operating principle of fuel cells (e.g., direct methane fuel cells, proton exchange membrane fuel cells, and biofuel cells) involves the reduction of oxygen over precious platinum metal catalysts deposited on carbon supports in a fuel cell's cathode. Currently, carbon nanotubes (CNTs) represent a promising carbon support in a fuel cell.

In general, CNTs have outstanding electrical and structural properties that make CNTs very attractive candidates for energy conversion device applications such as fuel cells and biofuel cells. CNTs present large surface areas and are porous thereby enabling the use of small amounts of metal catalyst to generate relatively high current levels. Unfortunately, the uniform deposition of metal nanoparticles (e.g., cobalt, copper, gold, platinum, silver, and other known electrode catalysts) on CNTs has been difficult to achieve.

Most known metal-to-CNT deposition techniques do not precisely control the size of metal nanoparticles to fabricate highly populated, well-dispersed nanoparticles on the CNTs. Also, the conventional processes used to fabricate CNT electrodes are complicated and require several difficult steps. These steps can include repeated centrifugation and re-dispersion in an organic solvent, and a dispersion of CNTs evenly in an aqueous solution that includes surfactants to achieve well-dispersed metal nanoparticles on the CNTs. Surfactants are used to combat CNTs' poor dispersion and solubility characteristics in solvents due to the substantial van der Waals attraction between tubes. However, these surfactants wrap around the CNTs thereby inhibiting the bonding of metal catalysts to the CNTs. Further, current solvent deposition techniques do not readily control the catalyst size and distribution, and do not readily provide for increases in the amount of catalyst on CNT electrodes. Finally, even if a metal catalyst is well-dispersed through chemical and/or electrochemical deposition on the CNTs, there are still problems related to the ability of catalysts in transporting generated protons to a proton exchange membrane.

### SUMMARY OF THE INVENTION

Accordingly, it is an object of the present invention to provide a method of fabricating electrodes for use in biofuel cell and fuel cell applications.

Another object of the present invention is to provide a method of fabricating electrodes using CNTs as catalyst supports.

Still another object of the present invention is to provide electrodes having CNT supports and a sufficient amount of catalyst deposited thereon such the electrodes can be used in biofuel cell and fuel cell applications.

other objects and advantages of the present invention will become more obvious hereinafter in the specification and drawings.

In accordance with the present invention, a method of fabricating electrodes for use in biofuel cells and fuel cells is provided. Carbon nanotubes (CNTs) are mixed in an aqueous buffer solution that consists of at least 50 weight percent water and a remainder weight percent that includes a buffer material having a molecular structure defined by a first end, a second end, and a middle disposed between the first and second ends The first end is a cyclic ring with nitrogen and oxygen heteroatomes, the middle is a hydrophobic alkyl chain, and the second end is a charged group. The resulting solution includes the CNTs dispersed therein. Metal-core ferritins are then mixed into the resulting solution where at least a portion of the ferritins are coupled to the CNTs. When the ferritins are cationized ferritins, the ferritins are electrostatically attached to the CNTs with the resulting fabricated electrodes being suitable for use in biofuel cells and fuel cells.

### BRIEF DESCRIPTION OF THE DRAWINGS

FIG. 1 is a molecular structure of 3-(N-morpholino)-propanesulfonic acid (MOPS) buffer material used in an aqueous buffer solution in accordance with the present invention;

FIG. 2 is a “scanning transmission electron microscopy” (STEM) image of CNTs having a population of platinum-core ferritins embedded therein resulting from mixing the platinum-core ferritins in the aqueous buffer solution; and

FIG. 3 is a STEM image of CNTs having a population of platinum-core cationized ferritins coupled thereto resulting from mixing the platinum-core cationized ferritins in the aqueous buffer solution.

### DETAILED DESCRIPTION OF THE INVENTION

The present invention's novel carbon nanotube (CNT) electrodes and fabrication thereof utilize a method of dispersing carbon nanotubes (CNTs) in an aqueous solution without additives such as surfactants, polymers, etc., that tend to wrap about the dispersed CNTs. This CNT dispersion method is disclosed in a co-pending U.S. patent application entitled “AQUEOUS SOLUTION DISPERSEMENT OF CARBON NANOTUBES,” filed by the same inventors and on the same date as the instant patent application. As used herein, the term CNTs includes single-wall CNTs (SWCNTs), few-wall CNTs (FWCNTs), multi-wall CNTs (MWCNTs), and mixtures thereof.

The present invention utilizes an aqueous buffer solution as the vehicle for CNT dispersion. As is known in the art, a buffer solution is an aqueous solution consisting of either a weak acid and its conjugate base, or a weak base and its conjugate acid. In either case, the property of a buffer solution is that its pH changes very little when a small amount of acid or base is added to it. Accordingly, buffer solutions are used to keep pH at a nearly constant value in various chemical applications.

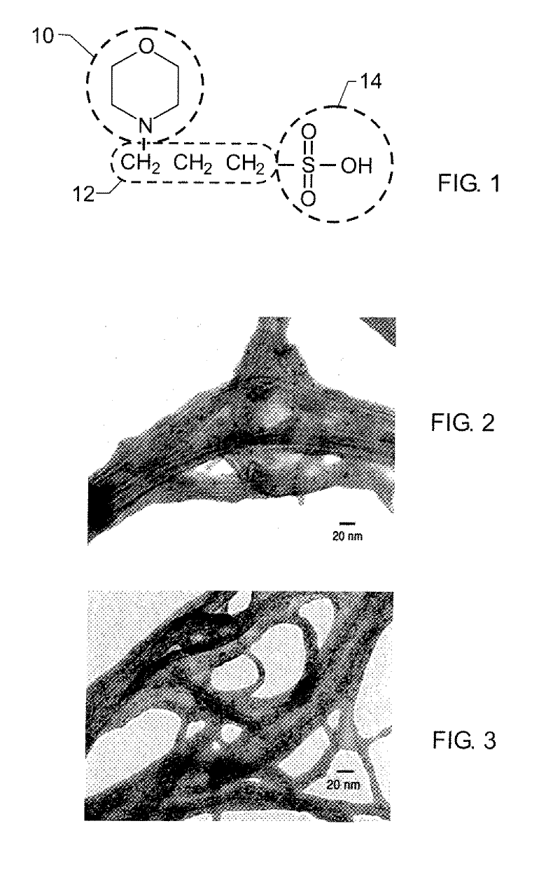

As discussed above, dispersing CNTs in an aqueous solution has generally required an additive in order to overcome the hydrophobic nature of CNTs. Unfortunately, these additives wrap around the CNTs and prevent attachment of reactants (e.g., catalysts in the case of CNT-based electrodes) to the CNTs. The present invention overcomes these problems by use of an aqueous buffer solution that includes water, a buffer material, and possibly salt. The buffer material is defined generally by a molecular structure having a cyclic ring with nitrogen and oxygen heteroatomes at one end, a charged group at the other end, and a hydrophobic alkyl chain between and coupling the cyclic ring to the charged group. One such suitable commercially-available buffer material is 3-(N-morpholino) propanesulfonic acid (or “MOPS” as it is known and will be referred to hereinafter). The molecular structure of the MOPS buffer is illustrated in FIG. 1 where the cyclic ring is contained within dashed-line circle 10, the alkyl chain is contained within dashed-line oval 12, and the charged group is contained within dashed-line circle 14. The alkyl chain 12 separates the hydrophobic cyclic ring 10 from the hydrophobic charged group 14. In general, a longer hydrophobic alkyl chain 12 improves CNT dispersion. For MOPS, the length of its alkyl chain is approximately 0.45 nanometers.

The aqueous buffer solution in the present invention comprises at least 50 weight percent water. The remaining weight percent of the aqueous buffer solution comprises a buffer material satisfying the above-described criteria and, optionally, a small amount of salt. When using the MOPS buffer material, good CNT dispersal was achieved when the weight percent of the MOPS buffer material was approximately between 1.05-50 weight percent.

The present invention's aqueous buffer solution can be mixed in accordance with well known solution making principles. That is, no special criteria need be adhered to when creating the solution. Once created, CNTs are added to the aqueous buffer solution. Based on dispersion analysis of a number of examples, good dispersion of CNTs resulted when the concentration of CNTs ranged up to approximately 1.0 milligrams per milliliter of the aqueous buffer solution. Initial mixing of the CNTs in the solution can be accomplished by stirring and/or sonication as would be understood in the art. In all test examples of the present invention, good dispersion of CNTs was visually evident after initial mixing with the clear aqueous buffer solution. That is, prior to mixing, the CNTs could be seen in aggregation in the clear solution whereas, after mixing, the entire mixture became opaque. Any subsequent aggregation of the CNTs was quickly remixed with just several minutes of sonication. Several examples of the present invention are detailed below.

### EXAMPLE 1

The aqueous buffer solution in this example comprised 2.1 weight percent MOPS, 0.29 weight percent salt, and a remaining weight percent of water. The pH of this solution was 7.5. CNTs were mixed at a ratio of 0.5 milligrams/milliliter of the aqueous buffer solution.

### EXAMPLE 2

The aqueous buffer solution in this example comprised 2.1 weight percent MOPS and a remaining weight percent water. No salt was added. The pH of this solution was 7.5. CNTs were mixed in at a ratio of 1.0 milligrams/milliliter of the aqueous buffer solution.

### EXAMPLE 3

The aqueous buffer solution in this example comprised 26 weight percent MOPS and a remaining weight percent of water. No salt was added. The pH of this solution was 7.5. CNTs were mixed in at a ratio 3.0 milligrams/milliliter of the aqueous solution. Note that this higher ratio of CNTs did not yield good dispersion results.

### EXAMPLE 4

The aqueous buffer solution in this example comprised 50 weight percent MOPS and a remaining weight percent of water. No salt was added. The pH of this solution was 7.5. CNTs were mixed in at a ratio of 0.5 milligrams/milliliter of the aqueous solution.

The advantages of the above-described CNT-dispersion method are numerous. The safe-to-handle aqueous buffer solution disclosed herein provides excellent CNT dispersion without use of additives that tend to wrap themselves about the CNTs. Thus, this method can serve as a cornerstone for the assembly of reactant materials on CNTs. For example, the aqueous buffer solution with CNTs dispersed therein could further have a variety of biomolecules mixed therewith. In general, biomolecules carrying a positive charge on the surface thereof are ideally suited to bond with the dispersed CNTs. Thus, the above-described method can serve as the building block for a number of biological or biophysical applications where CNTs serve as the vehicle for a particular biomolecule.

In accordance with the present invention, the above described method can serve as the initial construction steps for fabrication of electrodes that use CNTs as their support. This can be accomplished by mixing metal-core ferritins with the above-described “aqueous buffer solution with CNTs dispersed therein”. As will be explained further below, the ferritins are used to store nano-sized particles of metal. The ferritins have a natural affinity for the CNTs so that the stored nano-sized particles of metal can be distributed about the dispersed CNTs. This affinity can be enhanced by using cationized ferritins.

As is known in the art, ferritins are iron storage proteins involved in a variety of human, animal, and bacteria mechanisms. A ferritin molecule contains up to approximately 4500 Fe³⁺ atoms (e.g., Fe(OH)) within its hollow interior. The ferritin molecule consists of a segmented protein shield with an outer diameter of approximately 7.5 mm. The protein shell consists of 24 protein subunits that form a spherical exterior with channels through which molecules can enter and leave the protein. When the protein shell is empty and contains no iron, it is called apoferritin. Using a reconstitution process of site-specific biomineralization within the protein shell, apoferritins can be loaded with different core materials to include good electrode materials such as cobalt, copper, gold, iron, manganese, nickel, palladium, platinum, platinum-ruthenium alloy, ruthenium, ruthenium-tungsten alloy, and silver. Ferritin reconstitution processes are disclosed by Jae-Woo Kim et al. in “Cobalt Oxide Hollow Nanoparticles Derived by Bio-templating,” Chemical Communication, The Royal Society of Chemistry 2005, pp. 4101-4103, and by Jae-Woo Kim et al. in “Electrochemically Controlled Reconstitution of Immobilized Ferritins for Bioelectronic Applications,” Journal of Electroanalytical Chemistry 601 (2007), pp. 8-16.

By way of example, naturally existing ferritins were reconstituted with nano-sized particles of platinum. Specifically, horse spleen ferritins were reconstituted with platinum having 200 atoms per ferritin using site-specific chemical reduction explained in the references cited herein. The resulting platinum-core ferritins were mixed into a version of the above-described solution (i.e., 2.1 weight percent MOPS and remaining weight percent water) with dispersed CNTs. The naturally existing ferritins have a negatively charged surface in a pH environment of 7.5 because the isoelectric point of the ferritin is around a pH of 4.5. As a result, a number of the supplied platinum-core ferritins were electrostatically repelled from the CNTs. Even so, this still yielded a distributed population of platinum catalyst on the CNTs as evidenced in the STEM image shown in FIG. 2 where the platinum-core ferritins appear as dark spots on the lighter-shade CNTs. For the illustrated example, the CNTs were purified FWCNTs mixed in the aqueous buffer solution at a ratio of 0.03 milligrams/milliliter. The ratio of FWCNTs to platinum-core ferritins was 1 to 1.47 in terms of weight. The total platinum loading in the solution was 44.3 micrograms.

It was discovered that the population of the platinum catalyst could be increased by using cationized ferritins in the reconstitution process as opposed to naturally existing ferritins. As is known in the art, a cationized ferritin has positive charges on the protein surface through modification with N,N-dimethyl-1,3-propanediamine (DMPA). Fabrication of the platinum-core cationized ferritins followed the same process as fabrication of the platinum-core ferritins. When platinum-core cationized ferritins were mixed in the above-described solution with dispersed CNTs, greater numbers of the platinum-core cationized ferritins easily attached themselves to the negatively charged CNT surfaces via electrostatic forces. As a result, an increased population of catalyst material (i.e., in the form of platinum-core cationized ferritins) could be found on the CNTs as evidenced in the STEM image shown in FIG. 3 where the platinum-core cationized ferritins appear as dark spots/regions on the lighter-shade CNTs. The solution with the dispersed CNTs for this example again comprised 2.1 weight percent MOPS and a remaining weight percent water. For this example, the CNTs were purified SWCNTs mixed in the aqueous buffer solution at a ratio of 0.083 milligrams/milliliter. The ratio of SWCNTs to cationized platinum-core ferritins was 1 to 0.4 in terms of weight. The total platinum loading in the solution was 33.3 micrograms.

The electrodes fabricated in the two examples just described were then tested. The electrocatalytic behavior for oxygen reduction was better for the electrode made with platinum-core cationized ferritins. Specifically, the electrode made with platinum-core cationized ferritins showed oxygen reduction that commenced at a lower voltage potential while producing about twice the current density when compared to the electrode made with platinum-core ferritins. In addition to these improvements, it was also discovered that subsequent sonication of the electrodes made with the platinum-core cationized ferritins (still in the aqueous buffer solution) caused dissociation of the ferritins' protein shell. This allowed the platinum particles to be redistributed and reorganize into non-spherical groups thereby defining greater surface areas of platinum catalyst. The result was further improvements in electrode performance with respect to starting potential of oxygen reduction and current density.

The advantages of the above-described electrode fabrication method and resulting electrodes are numerous. CNTs are readily dispersed in a safe-to-handle aqueous buffer solution with the surfaces of the dispersed CNTs being available to react with a selected reactant. The use of ferritin proteins as the catalyst vehicle on a CNT support provides electrodes for both biofuel cell and fuel cell applications. This process involves safe-to-handle materials and is readily repeated using conventional mixing techniques. The catalytic effects of the resulting electrodes can be further enhanced by simple sonication to redistribute and re-shape the metal particles on the CNTs. Conversely, the use and retention of the ferritin proteins on the electrode can improve proton transport through the protein shield to thereby enhance the performance of the metal-core as a catalyst.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A method of fabricating electrodes for use in biofuel cells and fuel cells, comprising the steps of:
creating an aqueous buffer solution consisting of at least 50 weight percent water and a remainder weight percent that includes a buffer material having a molecular structure defined by a first end, a second end, and a middle disposed between said first end and said second end, said first end defined by a cyclic ring with nitrogen and oxygen heteroatomes, said middle defined by a hydrophobic alkyl chain, and said second end defined by a charged group;
mixing CNTs in said aqueous buffer solution in a ratio of up to approximately 1.0 milligrams of CNTs per 1.0 milliliter of said aqueous buffer solution wherein a resulting solution includes said CNTs dispersed therein; and
mixing metal-core ferritins into said resulting solution, wherein at least a portion of said ferritins are coupled to said CNTs.

2. A method according to claim 1, wherein said hydrophobic alkyl chain is at least approximately 0.45 nanometers in length.

3. A method according to claim 1, wherein said buffer material comprises 3-(N-morpholino)-propanesulfonic acid.

4. A method according to claim 1, wherein said CNTs comprise at least one of single-wall CNTs, few-wall CNTs, and multi-wall CNTs.

5. A method according to claim 1, wherein said ferritins are cationized ferritins.

6. A method according to claim 1, wherein a metal used in making said ferritins is selected from the group consisting of cobalt, copper, gold, iron, manganese, nickel, palladium, platinum, platinum-ruthenium alloy, ruthenium, ruthenium tungsten alloy, and silver.

7. A method according to claim 1, further comprising the step of sonicating said resulting solution containing said CNTs with said ferritins electostatically attached thereto.

8. A method of fabricating electrodes for use in biofuel cells and fuel cells, comprising the steps of:
mixing approximately 1.05-50 weight percent 3-(N-morpholino)-propanesulfonic acid with a remaining weight percent of water to form an aqueous buffer solution;
mixing CNTs in said aqueous buffer solution in a ratio of up to approximately 1.0 milligrams of CNTs per 1.0 milliliter of said aqueous buffer solution wherein a resulting solution includes said CNTs dispersed therein; and
mixing metal-core ferritins into said resulting solution, wherein at least a portion of said ferritins are coupled to said CNTs.

9. A method according to claim 8, wherein said CNTs comprise at least one of single-wall CNTs, few-wall CNTs, and multi-wall CNTs.

10. A method according to claim 8, further comprising the step of sonicating said resulting solution containing said CNTs with said ferritins electostatically attached thereto.

11. A method according to claim 8, wherein said ferritins are cationized ferritins.

12. A method according to claim 8, wherein a metal used in making said ferritins is selected from the group consisting of cobalt, copper, gold, iron, manganese, nickel, palladium, platinum, platinum-ruthenium alloy, ruthenium, ruthenium-tungsten alloy, and silver.

13. A method of fabricating electrodes for use in biofuel cells and fuel cells, comprising the steps of:
creating an aqueous buffer solution consisting of at least 50 weight percent water and a remainder weight percent of a buffer material having a molecular structure defined by a first end, a second end, and a middle disposed between said first end and said second end, said first end defined by a cyclic ring with nitrogen and oxygen heteroatomes, said middle defined by a hydrophobic alkyl chain that is at least approximately 0.45 nanometers in length, and said second end defined by a charged group;
mixing CNTs in said aqueous buffer solution in a ratio of up to approximately 1.0 milligrams of CNTs per 1.0 milliliter of said aqueous buffer solution wherein a resulting solution includes said CNTs dispersed therein; and
mixing metal-core ferritins into said resulting solution, wherein at least a portion of said ferritins are coupled to said CNTs.

14. A method according to claim 13, wherein said buffer material comprises 3-(N-morpholino)-propanesulfonic acid.

15. A method according to claim 13, wherein said CNTs comprise at least one of single-wall CNTs, few-wall CNTs, and multi-wall CNTs.

16. A method according to claim 13, further comprising the step of sonicating said resulting solution containing said CNTs with said ferritins electostatically attached thereto.

17. A method according to claim 13, wherein said ferritins are cationized ferritins.

18. A method according to claim 13, wherein a metal used in making said ferritins is selected from the group consisting of cobalt, copper, gold, iron, manganese, nickel, palladium, platinum, platinum-ruthenium alloy, ruthenium, ruthenium-tungsten alloy, and silver.

19. An electrode for use in biofuel cells and fuel cells, comprising:
a carbon nanotube (CNT); and
a plurality of metal-core cationized ferritins electrostatically attached to said CNT.

20. An electrode as in claim 19, wherein said CNT is selected from the group consisting of single-wall CNTs, few-wall CNTs, and multi-wall CNTs.

21. An electrode as in claim 19, wherein a metal in said metal-core cationized ferritins is selected from the group consisting of cobalt, copper, gold, iron, manganese, nickel, palladium, platinum, platinum-ruthenium alloy, ruthenium, ruthenium-tungsten alloy, and silver.

22. Electrodes for use in biofuel cells and fuel cells, comprising:
a plurality of carbon nanotubes (CNTs); and
a plurality of metal-core cationized ferritins electrostatically attached to each of said CNTs.

23. Electrodes as in claim 22, wherein said CNTs comprise at least one of single-wall CNTs, few-wall CNTs, and multi-wall CNTs.

24. Electrodes as in claim 22, wherein a metal in said metal core cationized ferritins is selected from the group consisting of cobalt, copper, gold, iron, manganese, nickel, palladium, platinum, platinum-ruthenium alloy, ruthenium, ruthenium-tungsten alloy, and silver.
